(19) United States
(12) Patent Application Publication
(10) Pub. No.: US 2012/0121887 A1
(43) Pub. Date: May 17, 2012

(54) METHOD FOR PREPARING A FOAM COMPOSITE ELEMENT

(75) Inventors: Johannes Van De Braak, Hennef (DE); Rene Abels, Koln (DE); Rolf Roers, Odenthal (DE); Peter Haas, Haan (DE)

(73) Assignee: Bayer MaterialScience AG, Leverkusen (DE)

(21) Appl. No.: 13/322,172

(22) PCT Filed: May 14, 2010
(86) PCT No.: PCT/EP2010/002964

§ 371 Date: Jan. 25, 2012

(30) Foreign Application Priority Data
May 29, 2009 (EP) 09007176.2
Apr. 15, 2010 (EP) 10003991.6

(51) Int. Cl. B05D 3/10; B32B 27/10; B32B 27/06

(52) U.S. Cl. 428/317.7; 427/302; 427/303

(57) ABSTRACT

The invention relates to a method for preparing a foam composite element, including the steps of preparing a top layer, applying an adhesion promoter layer to the top layer, wherein the adhesion promoter layer includes a modified isocyanate, and applying a foam layer including polyurethane and/or polyisocyanurate to the adhesion promoter layer. On application, the modified isocyanate in the adhesion promoter layer has a content of free isocyanate groups of from ≧10% to ≦29%. The invention further relates to the use of a modified isocyanate having a content of free isocyanate groups of ≧10% to ≦29% as an adhesion promoter in the preparation of foam composite elements and foam composite elements obtained by the method according to the invention.

The invention relates to a method for preparing a foam composite element, including the steps of preparing a top layer, applying an adhesion promoter layer to the top layer, wherein the adhesion promoter layer includes a modified isocyanate, and applying a foam layer including polyurethane and/or polyisocyanurate to the adhesion promoter layer. On application, the modified isocyanate in the adhesion promoter layer has a content of free isocyanate groups of from ≧10% to ≦25%. The invention further relates to the use of a modified isocyanate having a content of free isocyanate groups of from ≧10% to ≦25% as an adhesion promoter in the preparation of foam composite elements and foam composite elements obtained by the method according to the invention.

For the continuous manufacture of metal sandwich elements based on polyurethane hard foams, that is to say both polyurethane and polyisocyanurate hard foams, the adhesive strength of the metal top layer to the foam is important, particularly if the foam is a polyisocyanurate foam. Two-component polyurethane adhesion promoter systems are known on the market. Adhesive strengths are in principle significantly improved by the use of two-component adhesion promoter systems of this kind, which from the manufacturers' point of view means that the finished parts are an improved product. In particular, the long-term risks of adhesion failure are dramatically reduced.

However, when processing two-component adhesion promoter systems of this kind, difficulties arise in the sufficient homogenisation of the adhesion promoter components. Insufficient homogenisation may present a high risk to the long-term composite properties of the metal composite elements in that fluctuating temperatures may lead to failure of the adhesion of the top layer to the foam. Further, processing a two-component adhesion promoter system may result in a relatively high level of rejects at the start of a production phase.

A way of avoiding the risk of deficient composite properties resulting from insufficient homogenisation of the two adhesion promoter components is presented by one-component solutions. For example, EP 1 516 720 A1 discloses the use of a polyurethane adhesion promoter to improve adhesion between the layers of a composite element containing a polyisocyanurate foam and top layers, and the composite elements per se and a method for the preparation thereof.

EP 1 593 438 A2 discloses a device and a method for preparing sandwich composite elements. The device comprises at least two feed devices for top layers, to which an application device for an adhesion promoter, an application device for a core layer, a conveying device and a diverting device are connected one after the other. The application device for the adhesion promoter comprises at least a feed line for the adhesion promoter, a turntable having at least one lateral exit opening, and a drive for the turntable. Possible adhesion promoters which may be used are one-component systems, for example those based on polyurethane, such as prepolymers containing NCO groups. Further possible one-component systems are based on polychloroprene, epoxy or polyvinyl acetate. The adhesion promoter may also be composed of a multi-component system, preferably a two-component system. Preferred two-component systems are polyurethane systems.

The object of the present invention is to improve the adhesion between the foam and the top layers in foam composite elements. There is consequently a need for alternative and improved methods for preparing these composite elements which in particular make it possible to improve adhesion between the foam and the top layers in foam composite elements while at the same time reducing the occurrence of blisters and/or weakened points. In practical use, for sufficient adhesion between the top layer and the foam layer, a lower limit of 0.20 N/mm² (measured to DIN 53292) is regarded as the critical limit. The object is thus to make the adhesive strength between the top layer and the foam layer as great as possible while at the same time using the smallest possible quantity of adhesion promoter.

Surprisingly, it has been found that the object according to the invention is achieved by a method for preparing a foam composite element, including the steps of:
A) preparing a top layer;
B) applying an adhesion promoter layer to the top layer, wherein the adhesion promoter layer includes a modified isocyanate; and
C) applying a foam layer including polyurethane and/or polyisocyanurate to the adhesion promoter layer,
   characterised in that, on application, the modified isocyanate in the adhesion promoter layer has a content of free isocyanate groups of from ≧10% to ≦29%, preferably from ≧10% to ≦25%.

The content of free isocyanate groups is indicated in each case by weight % in relation to the quantity of isocyanate used.

It has been found that using a modified isocyanate according to the invention as an adhesion promoter allows the adhesion of the foam to the top layer to be improved by comparison with known systems. In particular, the use of modified isocyanates in the form of prepolymers, that is to say one-component systems according to the conventional technology, makes it possible to avoid unsatisfactory mixing ratios when two-component systems are used. Unsatisfactory mixing in adhesion promoter systems would result in blistering or weakened points in the composite material. Advantageously, the use of modified isocyanates in the form of prepolymers also makes it possible to wet the top layer over its entire surface.

The foam composite elements prepared according to the invention are in particular suitable as thermal insulation elements.

Step A) of the method according to the invention relates to the preparation of a top layer. This preparation may be performed in continuous production plants, for example by unwinding a rolled-up top layer from a roll. The type of top layer is not initially specified in more detail, and in this case the materials conventionally used in the sector of heat insulation for top layers may be used. The thickness of the top layer may for example be from ≧200 μm to ≦5 mm, preferably from ≧300 μm to <2 mm and particularly preferably from ≧400 μm to ≦1 mm.

In step B), an adhesion promoter layer including modified isocyanate is applied to the prepared top layer. Application may be by conventional techniques such as spraying or rolling. Preferred modified isocyanates include: urea-modified isocyanates; biuret-modified isocyanates; urethane-modified isocyanates; isocyanurate-modified isocyanates; allophanate-modified isocyanates; carbodiimide-modified isocyanates; uretdione-modified isocyanates and uretonimine-modified isocyanates. Modified isocyanates of this kind are commercially available and are prepared by reacting an isocyanate with a smaller than stoichiometric quantity of an isocyanate-reactive compound or with itself. For example, urea-modified and urethane-modified isocyanates may be prepared by reacting di- or polyisocyanate with relatively small amounts of water or a diamine or with a glycol respectively. Carbodiimide-, uretonimine- and isocyanurate-modified isocyanates are prepared by a reaction in which isocyanates are replaced by themselves in the presence of suitable catalysts.

A particularly preferred modified isocyanate is a carbodiimide-modified or urethane-modified isocyanate.

A most particularly preferred modified isocyanate is a urethane-modified isocyanate. A urethane-modified isocyanate may also be called a polyurethane prepolymer. Here, the term “prepolymer” is used in its conventional sense. The term “polyurethane prepolymer” is used in particular of reactive intermediates when reacting isocyanates to give polyurethane polymers. It is prepared by reacting a polyol component with an excess of an isocyanate component.

Preferably, the isocyanate component is selected from the group comprising tetramethylene diisocyanate, methylpentamethylene diisocyanate, hexamethylene diisocyanate-1,6, dodecamethylene diisocyanate, 1,4-diisocyanato-cyclohexane, 1-isocyanato-3,3,5-trimethyl-5-isocyanatomethyl-cyclohexane, 4,4′-diisocyanato-dicyclohexyl-methane, 4,4′-diisocyanato-dicyclohexylpropane-(2,2), 1,4-diisocyanatobenzene, 2,4-diisocyanatotoluene, 2,6-diisocyanatotoluene, 4,4′-diisocyanato-diphenylmethane, 2,2′- and 2,4′-diisocyanato-diphenylmethane, p-xylylene diisocyanate, 1,3- and 1,4-diisocyanatomethyl-benzene and mixtures of these compounds. It is particularly preferred for the isocyanate component to be diphenylmethane diisocyanate.

The thickness of the adhesion promoter layer may for example be from ≧200 μm to ≦5 mm, preferably from ≧300 μm to ≦2 mm and particularly preferably from ≧400 μm to ≦1 mm.

The use of modified isocyanates as adhesion promoters makes it possible for the production of foam composite elements to be interrupted without a relatively large quantity of rejects being produced. Whereas conventional adhesion promoters based on two-component systems finish reacting within a short time, modified adhesion promoters are latent-reactive. Thus, the production of foam composite elements can advantageously be stopped as soon as problems in the production process arise without large quantities of material having to be thrown away.

In step C), a foam layer including polyurethane and/or polyisocyanurate is applied to the adhesion promoter layer. This may also be performed in a continuous projection plant. This layer may for example be present in a thickness of from ≧2 cm to ≦25 cm, from ≧5 cm to ≦23 cm and preferably from ≧12 cm to ≦20 cm. Mixing of the reaction components in a mixing head may be only just before application, and the reaction mix that gives the foam may be applied directly to the adhesion promoter layer. As an alternative, the finished foam layer may be applied, for example being laid on. In particular, the use of foams including polyisocyanurate or predominantly of polyisocyanurate is advantageous, since these have good flame retardant properties even with a reduced content of flame retardants.

For preparing the foam layer, conventional aliphatic, cycloaliphatic and in particular aromatic polyisocyanates may be used. It is particularly preferable to use toluylene diisocyanate (TDI), diphenylmethane diisocyanate (MDI) and in particular mixtures of diphenylmethane diisocyanate and polyphenylene polymethylene polyisocyanates (raw MDI). Possible compounds having at least two hydrogen atoms that are reactive with isocyanate groups are in general those having two or more reactive groups in the molecule, selected from OH groups, SH groups, NH groups, NH₂ groups and CH-acid groups such as β-diketo groups. It is preferable to use polyetherols and/or polyesterols, polyether polyols being preferred. The hydroxyl number of the polyetherols and/or polyesterols used is preferably from 25 to 800 mg KOH/g, and the molar masses are generally greater than 400 g/mol.

According to the invention, on application, the modified isocyanate in the adhesion promoter layer has a content of free isocyanate groups of from ≧10% to ≦29%, preferably from ≧10% to ≦25%. Here, the content of isocyanate groups before the adhesion promoter layer has come into contact with the foam layer is to be understood. It is particularly preferable for the content of free isocyanate groups to lie in a range of from ≧12% to ≦20%. This can be determined using the DIN standard 53 185. The content of free isocyanate groups that is given indicates the content at the time of applying it to the top layer.

In a preferred embodiment, the foam layer—which is to be understood in general to include the foam in the foam layer—has a content of closed cells of from ≧85% to ≦100%, preferably from ≧90% to ≦100%, the content of closed cells being determined to DIN ISO 4590. Preferably, the foam layer has an average cell diameter to ASTM 3576-77 of from ≧10 μm to ≦600 μm, preferably from ≧50 μm to ≦400 μm.

In the method according to the invention, after step C) a further adhesion promoter layer may be applied to the foam layer, as in step B), and thereafter a further top layer may be applied, as described in step A). This gives a foam composite element which is provided with a top layer on both sides. The method may for example be performed in a conventional double-band plant.

In an embodiment of the method according to the invention, the material of the top layer includes aluminium, steel, bitumen, paper, mineral nonwovens, nonwovens including organic fibres, synthetic panels, synthetic films and/or timber panels. It is particularly preferred if the top layer is aluminium metal or steel. The aluminium or steel may in this case be coated. The modified isocyanates which are used according to the invention, in particular urethane-modified isocyanates, give particularly good adhesion in particular between polyisocyanurate foam and an aluminium top layer or steel top layer.

In a preferred embodiment of the method according to the invention, the urethane-modified isocyanate in the adhesion promoter layer may be obtained by reacting monomeric and/or polymeric diphenylmethane diisocyanate with a polyether polyol having an average functionality of from ≧2 to ≦8, preferably from ≧3 to ≦8, particularly preferably from ≧3 to ≦6. Preferably, the polyether polyol has a content of secondary hydroxyl groups of from ≧50 mol % to ≦100 mol %. For example, a mixture of monomeric diphenylmethane diisocyanate and polymeric diphenylmethane diisocyanate with proportions of ≧5 weight % to ≦15 weight % of the 2,4′ isomer, ≧75 weight % to ≦85 weight % of the 4,4′ isomer and ≧5 weight % to ≦15 weight % of a polymeric MDI having a viscosity at 25° C. of from ≧100 mPas to ≦300 mPas may be used. Here, the proportions of portions by weight % add up to ≦100%. The polyether polyol component may for example be prepared by adding propylene oxide and ethylene oxide to glycerine as the starter molecule. The proportion of propylene oxide may advantageously be from ≧80 to ≦95 weight % and the proportion of ethylene oxide may advantageously be from ≧5 to ≦20 weight %. Particularly preferably, the proportion of secondary hydroxyl groups in the polyether polyol may also lie in a range of from ≧60 mol % to ≦80 mol %.

Preferably, according to the method according to the invention, the adhesion promoter layer is applied to the top layer in a quantity of from ≧20 g/m² to ≦50 g/m². This represents a reduction in the required quantity of adhesion promoter layer by comparison with known methods. Surprisingly, it has also been found that in the method according to the invention optimum adhesion is achieved if the quantity of adhesion promoter layer applied to the top layer lies in a range of from ≧30 g/m² to ≦40 g/m² (cf. the results presented in Table 2).

In a preferred embodiment of the method according to the invention, after application of the adhesion promoter layer and the reaction mixture for preparing the foam layer, the top layer is heated to a temperature of from ≧30° C. to ≦70° C., particularly preferably from ≧40° C. to ≦60° C., most particularly preferably from ≧45° C. to ≦55° C. Heating the top layer has the result that the reaction in the adhesion promoter layer is accelerated and a firmer connection overall is obtained.

In a further preferred embodiment of the method according to the invention, the foam layer may be obtained by reacting a reaction mixture that includes polyisocyanates and at least one compound selected from the group comprising polyester polyols and polyether polyols, wherein the molar ratio of isocyanate groups to hydroxyl groups in the reaction mixture at the start of the reaction is from ≧1:1 to ≦5:1. In other words, the index of this reaction mixture is from 100 to 500. The index may also be from ≧150 to ≦350 or from ≧200 to ≦300. With ratios of this kind, it is predominantly polyisocyanurate foams which are obtained, which as stated above manage with smaller quantities of flame retardants and yet as a result of the method according to the invention can be made to adhere firmly to top layers, in particular aluminium top layers. The polyisocyanurate foam is preferably a hard foam, defined using its compressive stress at 10% compression, or at from ≧100 kPa to ≦300 kPa. This compressive stress or compressive strength may be determined using DIN 53421/DIN EN ISO 604. It may also lie in a range of from ≧150 kPa to ≦250 kPa or from ≧180 kPa to ≦280 kPa.

Preferably, in the method according to the invention the apparent density of the foam layer is from ≧25 g/l to ≦48 a particularly preferably from ≧35 g/l to ≦45 g/l. The apparent density of the foam layer is determined using ISO standard 845. In a most particularly preferable embodiment, the apparent density of the foam layer is from ≧37 g/l to ≦42 g/l, and even more preferably from ≧39 g/l to ≦40 g/l. Independently of this, it is further also possible for the foam layer—which is to be understood in general to include the foam in the foam layer—to have a content of closed cells of from ≧85% to ≦100%, preferably from ≧90% to ≦100%, the content of closed cells being determined to DIN ISO 4590. Further, the foam layer preferably has an average cell diameter to ASTM 3576-77 of from ≧10 μm to ≦600 μm, particularly preferably from ≧50 μm to ≦400 μm.

The present invention further relates to the use of a modified isocyanate having a content of free isocyanate groups of from ≧10% to ≦29%, preferably from ≧10% to ≦25%, particularly preferably from ≧12% to ≦20%, as the adhesion promoter when preparing foam composite elements. Details on the modified isocyanate have already been described above, and those details may be referred to here in full.

In an embodiment of the method according to the invention, the urethane-modified isocyanate may be obtained by reacting monomeric and/or polymeric diphenylmethane diisocyanate with a polyether polyol having an average functionality of from ≧2 to ≦8, preferably from ≧2 to ≦6, particularly preferably from ≧2 to ≦3. In this regard too, the description above is referred to for the details.

### EXAMPLES

The present invention will be explained in more detail with reference to the examples below.

### Example 1

### Preparation of the Modified Isocyanate

A mixture of 527.0 g of an isocyanate composed of 10.0 weight % of 2,4′-diphenylmethane diisocyanate, 80.0 weight % of 4,4′-diphenylmethane diisocyanate and 10.0 weight % of a polymeric MDI having a viscosity of 200 mPa s at 25° C. and 472.0 g of a polyether polyol having an OH number of 46 mg KOH/g, prepared by adding 90 weight % of propylene oxide and 10 weight % of ethylene oxide to glycerine as the starter molecule with predominantly secondary hydroxyl groups, was reacted for two hours at 90° C. with stirring. The content of free isocyanate groups was determined as 15.3%. The viscosity at 25° C. was 1600 mPas.

### Example 2

The modified isocyanate was prepared in accordance with Example 1. 483.0 g of the isocyanate mixture from Example 1 was reacted with 347.0 g of a polyether polyol with an OH number of 28 mg KOH/g, prepared by adding 81 weight % of propylene oxide and 19 weight % of ethylene oxide to sorbitol as a starter, with predominantly primary hydroxyl groups. The content of free isocyanate groups was determined as 18.0%. The viscosity at 25° C. was 1100 mPas.

### Example 3

The modified isocyanate was prepared in accordance with Example 1. 450.0 g of the isocyanate mixture from Example 1 was reacted with 550.0 g of the polyether polyol from Example 1. The content of free isocyanate groups was determined as 12.1%. The viscosity at 25° C. was 3856 mPas.

### Example 4

The modified isocyanate was prepared in accordance with Example 1. 700.0 g of the isocyanate mixture from Example 1 was reacted with 300.0 g of the polyether polyol from Example 1. The content of free isocyanate groups was determined as 21.1%. The viscosity at 25° C. was 425 mPas.

### Example 4A

The modified isocyanate was prepared in accordance with Example 1. 700.0 g of a carbodiimidised 4,4′-diisocyanato-diphenylmethane having an NCO content of 29.5% and a carbodiimide content of 23% and 300 g of a polyether polyol having an OH number of 46, prepared by adding 90 weight % of propylene oxide and 10 weight % of ethylene oxide to glycerine as a starter, with predominantly secondary hydroxyl groups, was reacted. The content of free isocyanate groups was determined as 19.5%. The viscosity at 25° C. was 635 mPas.

### Example 5 (Comparison)

100 g of an isocyanate mixture from Example 1 was added dropwise to 1547.0 g of a polyether polyol having an OH number of 56 mg KOH/g, prepared by adding 100 weight % of propylene oxide to ethylene glycol as the starter, and the reaction mixture was heated at 95° C. for 2 h. No free NCO groups could still be detected. The viscosity at 25° C. was 5497 mPas.

### Example 6

### Preparation of the Modified Isocyanate

A mixture of 2640.0 g of the isocyanate mixture from Example 1 was reacted with 360.0 g of the polyether polyol from Example 1 for two hours at 95° C. with stirring. The content of free isocyanate groups was determined as 27.8%. The viscosity at 25° C. was 96 mPas.

### Example 7

### Preparation of the Modified Isocyanate

A mixture of 969.0 g of the isocyanate mixture from Example 1 and 2031.0 g of the polyether polyol from Example 1 was reacted for two hours at 95° C. with stirring. The content of free isocyanate groups was determined as 7.8%. The viscosity at 25° C. was 13491 mPas.

### Examples 8 to 16

The respective adhesion promoter composition was applied to an aluminium sheet that had been preheated to 40° C., using a device as described in EP 1 593 438 A2. The quantity of adhesion promoter used in each case is indicated in Table 1.

Then, a polyisocyanurate foam of the following composition was applied:

A component:

39 parts of polyether esterol 1 comprising phthalic acid anhydride, diethylene glycol and ethylene glycol with a functionality of 2 and a hydroxyl number of 310 mg KOH/g. 15.7 parts of polyetherol 1 comprising propylene glycol, propylene oxide and ethylene oxide with a functionality of 2 and a hydroxyl number of 28 mg KOH/g;

12 parts of polyetherol 2 comprising sugar, ethylene glycol and propylene oxide with a functionality of 3 and a hydroxyl number of 380 mg KOH/g;

25 parts of flame retardant 1 (tris-chloro-isopropyl phosphate, TCPP);

5 parts of stabiliser 1 (silicone-containing stabiliser);

3.5 parts of catalyst 1 (PIR catalyst, salt of a carboxylic acid);

2.5 parts of a polyesterol 1 (comprising phthalic acid anhydride and diethylene glycol);

2.5 parts of catalyst 2 (amine-containing polyurethane catalyst);

Blowing agent 1 (n-pentane), blowing agent 2 (water)

B component:

Desmodur 44V70L (polymeric MDI, available from Bayer Material Science AG)

The adhesive strength was tested using DIN standard 53292. Here, it was carried out in a different way from the tensile test to DIN 53292-82 perpendicular to the plane of the top layer, in that the sample thickness and number of top layers were different. In the test to DIN 53292-82, the total thickness of the top layers is taken as a basis. Here, the weakest area of the total sample determines the location of the breakage. In contrast, the adhesion test with the modification described here enables the adhesion to be assessed in relation to the side.

For this reason, in taking the sample a composite element was cut perpendicular to the top layers. For the measurement, square samples with a side length of 50 mm and a sample height of 15 mm (including the top layer) were used.

Blistering after a heat treatment at 105° C. for 1 h was also tested.

TABLE 1
Variation in the adhesion promoter used

| | Adhesion | | | |
|---|---|---|---|---|
| | promoter | | | |
| | according to | Quantity applied | Adhesion [N/mm²] | Blister- |
| Example | Example | [g/m²] | to the underside | ing |
| 8 | 1 | 50 | 0.22 | none |
| 9 | 2 | 50 | 0.23 | none |
| 10 | 3 | 50 | 0.24 | none |
| 11 | 4 | 50 | 0.21 | none |
| 12 | 4A | 50 | 0.23 | none |
| 13 (comp.) | 5 | 50 | —¹⁾ | present |
| 14 | 6 | 45 | 0.21 | none |
| 15 (comp.) | 7 | —²⁾ | —²⁾ | —²⁾ |
| 16 (comp.) | Polymeric | 50 | No adhesion⁴⁾ | —⁴⁾ |
| | MDI³⁾ | | | |

¹⁾Not measured because blistering occurred
²⁾Prepolymers not applied because viscosity was too great.
³⁾As the adhesion promoter, Desmodur 44V70L (polymeric MDI, available from Bayer Material Science AG, content of free isocyanate groups determined as 31.0%) was used.
⁴⁾There was no adhesion at all; both directly after foaming and 24 h after foaming the top layer detached itself from the polyisocyanate foam without any measurable adhesion.
comp. = comparative example

It was also observed that in the system according to the invention, after the foam composite element had been stored under heat at 105° C. for 1 hour, the interface region between the foam and the top layer was free of blistering in the region of the lower top layer. When no adhesion promoter was used, or if the two-component adhesion promoters were insufficiently mixed, undesirable blistering occurred during the storage under heat, in the region of the lower top layer.

### Examples 17 to 22

The modified isocyanate according to Example 1 was used as the adhesion promoter, and the quantity of adhesion promoter used was varied. The adhesion promoter composition was applied to an aluminium sheet that had been preheated to 40° C. using a device as described in EP 1 593 438 A2. The quantity of adhesion promoter used is indicated in Table 2.

Then, a polyisocyanurate foam of the following composition was applied:

A component:

31 parts of polyether ester polyol 1 comprising phthalic acid anhydride, diethylene glycol, sorbitol and propylene oxide with a functionality of 5 and a hydroxyl number of 435 mg KOH/g.

10 parts of polyester polyol 1 comprising phthalic acid anhydride, adipic acid, oleic acid and trimethylol propane with a functionality of 6.2 and a hydroxyl number of 370 mg KOH/g;

7 parts of polyether polyol 1 comprising trimethylol propane and propylene oxide with a functionality of 3 and a hydroxyl number of 380 mg KOH/g;

3 parts of polyether polyol 2 comprising toluoylene diamine and ethylene oxide and propylene oxide with a functionality of 4 and a hydroxyl number of 420 mg KOH/g;

12 parts of polyether polyol with halogen components comprising dibromo-butenediol and epichlorohydrin with a functionality of 3 and a hydroxyl number of 235 mg KOH/g;

31 parts of flame retardant 1 (tris-chloro-isopropyl phosphate, TCPP); 3.5 parts of glycerine;

2 parts of OS 340 (silicone-containing stabiliser, available from Bayer Material Science AG);

2.5 parts of Desmorapid 1792 (PIR catalyst, salt of a carboxylic acid, available from Bayer Material Science AG);

3.5 parts of Desmorapid VP 1221 VN (amine-containing polyurethane catalyst, available from Bayer Material Science AG);

Blowing agent 1 (n-pentane);

Blowing agent 2 (water)

B component:

Desmodur 44V70L (polymeric MDI, available from Bayer Material Science AG)

The adhesive strength was tested in the manner described above.

TABLE 2
Variation in the quantity of adhesion promoter
(prepolymer according to Example 1)

| | Adhesion | Quantity | |
|---|---|---|---|
| | promoter | applied | Adhesion [N/mm²] |
| Example | according to | [g/m²] | to the underside |
| 17 | Example 1 | 25 | 0.39 |
| 18 | Example 1 | 30 | 0.42 |
| 19 | Example 1 | 32 | 0.58 |
| 20 | Example 1 | 40 | 0.45 |
| 21 | Example 1 | 45 | 0.40 |
| 22 | Example 1 | 50 | 0.40 |

1.-15. (canceled)

16. A method for preparing a foam composite element, comprising the steps of:
A) providing a top layer;
B) applying an adhesion promoter layer to the top layer, wherein the adhesion promoter layer comprises a modified isocyanate; and
C) applying a foam layer comprising polyurethane and/or polyisocyanurate to the adhesion promoter layer;
wherein, on application, the modified isocyanate in the adhesion promoter layer has a content of free isocyanate groups of from 10% to 29%.

17. The method according to claim 16, wherein, on application, the modified isocyanate in the adhesion promoter layer has a content of free isocyanate groups of from 10% to 25%.

18. The method according to claim 16, wherein the top layer comprises aluminium, steel, bitumen, paper, mineral nonwovens, nonwovens including organic fibres, synthetic panels, synthetic films, timber panels, or a combinations thereof.

19. The method according to claim 16, wherein the modified isocyanate comprises a modified isocyanate selected from the group selected from the group consisting of urea-modified isocyanates; biuret-modified isocyanates; urethane-modified isocyanates; isocyanurate-modified isocyanates; allophanate-modified isocyanates; carbodiimide-modified isocyanates; uretdione-modified isocyanates; uretonimine-modified isocyanates; and mixtures thereof.

20. The method according to claim 19, wherein the modified isocyanate is a carbodiimide-modified or urethane-modified isocyanate.

21. The method according to claim 20, wherein the urethane-modified isocyanate in the adhesion promoter layer may be obtained by reacting monomeric and/or polymeric diphenylmethane diisocyanate with a polyether polyol, wherein the polyether polyol has an average functionality of from 2 to 8.

22. The method according to claim 16, wherein the adhesion promoter layer is applied to the top layer in an amount of from 20 g/m² to 50 g/m².

23. The method according to claim 16, wherein the adhesion promoter layer is applied to the top layer in an amount of from 30 g/m² to 40 g/m².

24. The method according to claim 16, wherein the foam layer may be obtained by reacting a reaction mixture that comprises polyisocyanates and at least one compound selected from the group consisting of polyester polyols and polyether polyols, wherein the molar ratio of isocyanate groups to hydroxyl groups in the reaction mixture at the start of the reaction is from 1:1 to 5:1.

25. The method according to claim 16, wherein the apparent density of the foam layer is from 25 g/l to 48 g/l.

26. The method according to claim 16, wherein the top layer comprises aluminium, steel, paper, synthetic panels, synthetic films, timber panels, or a combination thereof; and wherein the adhesion promoter comprises a urethane-modified isocyanate which may be obtained by reacting monomeric and/or polymeric diphenylmethane diisocyanate with a polyether polyol, and wherein the adhesion promoter layer is applied to the top layer in an amount of from 20 g/m² to 50 g/m².

27. A foam composite element obtained from the method according to claim 16.

28. The foam composite element according to claim 27, wherein the modified isocyanate comprises a modified isocyanate selected from the group consisting of urea-modified isocyanates; biuret-modified isocyanates; urethane-modified isocyanates; isocyanurate-modified isocyanates; allophanate-modified isocyanates; carbodiimide-modified isocyanates; uretdione-modified isocyanates; uretonimine-modified isocyanates; and mixtures thereof.

29. The foam composite element according to claim 27, wherein the modified isocyanate is a carbodiimide-modified or urethane-modified isocyanate.

30. The foam composite element according to claim 29, wherein the urethane-modified isocyanate may be obtained by reacting monomeric and/or polymeric diphenylmethane diisocyanate with a polyether polyol having an average functionality of from 2 to 8.
